(19) United States
(12) Patent Application Publication
(10) Pub. No.: US 2012/0127637 A1
(43) Pub. Date: May 24, 2012

(54) RECEPTACLE TIMER

(76) Inventors: Norman R. BYRNE, Ada, MI (US); Daniel Byrne, Grattan Township, MI (US)

(21) Appl. No.: 13/253,625

(22) Filed: Oct. 5, 2011

Related U.S. Application Data
(60) Provisional application No. 61/389,849, filed on Oct. 5, 2010.

(51) Int. Cl. H02B 1/01

(52) U.S. Cl. 361/627

(57) ABSTRACT

A timer assembly is slidably received within a channel support (120) for mounting on a work surface (280). The timer assembly (200) includes a set of controls (204). The assembly (200) is connectable to a simplex receptacle (142) for controlling the times at which the simplex receptable (142) is enabled and disabled. A remote control device (286) is operable by a user for transmitting spatial signals to the timer assembly (200) so as to control the timer assembly (200).

### CROSS-REFERENCE TO RELATED APPLICATIONS

This application is based upon and claims priority of U.S. Provisional Patent Application Ser. No. 61/389,849 filed Oct. 5, 2010.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The invention relates to power and data components for use in power distribution systems and, more particularly, to the use of a timer device for enabling and disabling the power and data components.

2. Background Art

With various types of power distribution assemblies, various numbers of electrical receptacles, data ports, communication ports, and other electronic elements may be utilized. It would be advantageous if there was commonality among the various types of electrical elements which may be utilized within a power distribution assembly. Further, it would be advantageous if these electrical elements could be readily reassembled in terms of configurations, and also utilize a means for receiving and supporting the electrical elements.

Further, it would be advantageous to have the capability of enabling and disabling various power and data components at various times, without requiring any type of physical activity on the part of the user at the times that the elements are to be enabled or disabled. The capability of enabling and disabling power and data distribution components may involve a type of timing or similar device. The following briefly summarizes various example timer devices known in the prior art.

For example, the U.S. Pat. No. 5,430,598 to Rodolfo, et al. discloses a programmable time interval power strip having a timer associated with enabling and disabling the power strip receptacles. A similar power strip with an electronic clock is disclosed in the U.S. Pat. No. 6,476,523 to Lee. A timer embedded within an electrical receptacle block is shown in the U.S. Pat. No. 7,527,519 to Van Dyne. General concepts associated with timer devices are shown in the following U.S. Patents and Publications: Blair, et al. U.S. Pat. No. 7,579,717; and Finneran US 2009/0261661.

The general concept of an AC power charging station for multiple charger adapters is disclosed in the U.S. Patent Publication to Vasko, et al. 2009/0115370. The charging station associated with Vasko, et al. includes a housing with a stowage volume having room to accommodate multiple charger adapters. At least one AC outlet is accessible from the stowage volume, and at least one relay is connected to a relay controlled AC outlet accessible from the stowage volume. A timer activation switch is utilized to activate the timer to enable and disable power cycles.

Some known devices are directed specifically to battery charging systems having timers. An early system for controlling charge cycles for standard storage batteries is disclosed in the U.S. Pat. No. 3,081,426 to Bakke. Timers for charging the batteries of a cell phone are disclosed in the U.S. Pat. No. 6,534,953 to Shirakawa. Other patents generally disclosing battery chargers having timing functions include the following: Nakasho, et al. U.S. Pat. No. 7,187,156; Bourilkov, et al. 2008/0238359; Bourilkov, et al. 2008/0238363; and Nethken 2009/0230919.

Other patents disclose the concept of utilizing timer devices in the form of an adapter or the like between a receptacle and a device to be powered or charged. In this regard, the U.S. Pat. No. 4,001,527 to Hulshizer discloses an electrical timer switch with a clock motor which can be plugged into a wall receptacle so as to establish a shunt.

Other references showing the general concept of a separate adapter or the like for the timing function include the following: Goldstein, et al. U.S. Pat. No. 4,349,748; Jung U.S. Pat. No. 6,356,425; Farsetta U.S. Pat. No. 6,798,631; Dunfield, et al. U.S. Pat. No. 6,903,284; Hollis, et al. U.S. Pat. No. 7,231,262; Windgassen, et al. 2003/0085625; Hermetz, et al. 2004/0178683; and Jodoin, et al. 2008/0023306. The U.S. Pat. No. 5,306,165 to Nadeau discloses general concepts associated with an electrical distribution system having various tracks and receptacle blocks.

### SUMMARY OF THE INVENTION

In accordance with the invention, a power distribution assembly supplies electrical power or communication signals from an energy source or communication signal source. The assembly is positioned on a work surface and includes a first electrical component connected to a source of electrical power or communication signals. The component supplies electrical power or communication signals to an external device connectable thereto. A channel support is mounted to the work surface, and a first electrical component is slidably received within the channel support. A timer assembly is directly or indirectly connectable to the electrical component, for controlling enablement and disablement of the component. The timer assembly is slidably received within the channel support.

The timer assembly includes a set of controls operable by a user for controlling the first electrical component. The power distribution assembly can include a series of electrical components, each connectable to a source of electrical power or communication signals. The timer assembly is directly or indirectly connectable to each of the electrical components. The electrical component and the timer assembly are slidably received within the channel support and positionable at any of a continuum of positions within the channel support. The assembly can include a remote control device manually operable by the user for controlling the timer assembly. Control is achieved through transmission spatial signals.

The timer assembly can include a timer face with numerical digits thereon, and a set of controls manually operable by the user for a setting the times for enablement and disablement of the component. The assembly can also include a face plate connectable to a front of the channel support. The face plate can include apertures for receiving the first electrical component and the timer assembly. The assembly can also include clamping elements for securing the channel support to the work surface.

Instead of the channel support, the distribution assembly can include a housing and a rotatable carriage mounted within the housing. The carriage is adapted to be movable between closed and open positions. The timer assembly is connectable to the first electrical component, and the electrical component and timer assembly are both received within the rotatable carriage. Alternatively, the timer assembly and the first electrical component can be mounted within an electrical receptacle block. The electrical receptacle block, in turn, is mounted within a junction block of the assembly. Further, the assembly can include an electrical raceway having components including end connectors, cable conduits and junction blocks. The electrical receptacle block carrying the electrical component and the timer assembly can be received within one of the junction blocks.

### BRIEF DESCRIPTION OF THE DRAWINGS

The invention will now be described with respect to the drawings, in which:

FIG. 1 is a rear view of a receptacle housing in accordance with the invention;

FIG. 2 is a plan view of the receptacle housing;

FIG. 3 is a left-side end view of the receptacle housing;

FIG. 4 is a front, elevation view of the receptacle housing;

FIG. 5 is a right-side end view of the receptacle housing;

FIG. 6 is an underside view of the receptacle housing;

FIG. 7 is a front, perspective view of the receptacle housing;

FIG. 8 is a rear, perspective view of the receptacle housing;

FIG. 9 is a rear, elevation view of a power and data channel support in accordance with the invention;

FIG. 10 is a plan view of the channel support shown in FIG. 9;

FIG. 11 is a left-side end view of the channel support;

FIG. 12 is a front, elevation view of the channel support;

FIG. 13 is a right-side end view of the channel support;

FIG. 14 is an underside view of the channel support;

FIG. 15 is a front, perspective view of the channel support;

FIG. 16 is a rear, perspective view of the channel support;

FIG. 17 is a front, perspective view of the receptacle housing shown in FIG. 1;

FIG. 18 is a perspective and partially exploded view of the receptacle housing shown in FIG. 17, and showing the relative positioning of the removable side latch tabs;

FIG. 19 is an exploded view of the receptacle housing shown in FIG. 17, and showing the main body of the receptacle housing consisting of the housing shell, a data port insert and a data port connector, thereby forming a data port assembly;

FIG. 20 is a perspective view of the data port assembly shown in FIG. 19, but shown in a fully assembled state;

FIG. 21 is a perspective view of a receptacle housing for a simplex receptacle;

FIG. 22 is a partially exploded and perspective view, showing the removable side latch tabs and the housing shell;

FIG. 23 is a perspective and exploded view showing the receptacle housing with a simplex receptacle;

FIG. 24 is a perspective view of the fully assembled simplex receptacle assembly;

FIG. 25 is a perspective view of the receptacle housing shown in FIG. 1;

FIG. 26 is a perspective view of the simplex receptacle assembly shown in FIG. 24;

FIG. 27 is a perspective view illustrating the use of the receptacle assembly with a data port;

FIG. 28 illustrates the use of the housing in a perspective view with a USB port and corresponding cable;

FIG. 29 illustrates a data port housing which may be utilized with an adapter assembly;

FIG. 30 illustrates a docking station in an open configuration, showing the docking station components;

FIG. 31 is a perspective and partially exploded view showing two of the data port assemblies as they are positioned so as to be received within the channel support;

FIG. 32 illustrates a further data port assembly which may be utilized and received within the channel support;

FIG. 33 illustrates the relative positioning of the docking station so as to be receivable within the channel support;

FIG. 34 is a perspective view showing the relative positioning of two of the receptacle assemblies positioned so as to be received within the channel support;

FIG. 35 illustrates a perspective view of the channel support with two of the data port assemblies, data port housing, docking station and two simplex receptacle assemblies, and also shows a relative positioning of a pair of side covers which can be releasably secured to the channel support;

FIG. 36 illustrates a perspective view of the fully assembled channel support and side covers;

FIG. 37 shows a portion of a data port as received within a portion of the channel support;

FIG. 38 is a sectional view, taken along section lines 38-38 of FIG. 37;

FIG. 39 is a perspective view of an assembled power and data assembly, having a cord, with three simplex receptacle assemblies and two data port assemblies;

FIG. 40 is a view of another type of power and data assembly, showing a single simplex receptacle assembly;

FIG. 41 is a further perspective view of another power and data port assembly, showing use of a channel support with a set of four data port housings and three simplex receptacle assemblies;

FIG. 42 shows the use of a channel support housing to simplex receptacle assemblies and a data port housing and utilized with a retractable light assembly;

FIG. 43 illustrates a further power and data assembly in perspective view, using a channel support, with a pair of data port assemblies and a pair of simplex receptacle assemblies;

FIG. 44 is an upper, perspective view of a simplex receptacle housing having a receptacle timer received therein in accordance with the invention;

FIG. 45 is an upper, perspective view of the simplex receptacle housing and receptacle timer shown in FIG. 44, adjacent a simplex receptacle assembly;

FIG. 46 is an upper, perspective view of a power element having the width of a duplex housing, a simplex receptacle housing and a receptacle timer received therein;

FIG. 47 is an exploded view of a receptacle timer in a position to be received by a simplex receptacle housing;

FIG. 48 is an assembled view of the element shown in FIG. 47;

FIG. 49 is a perspective view of a channel support corresponding to the channel support shown in FIG. 34, but showing the duplex assembly comprising the receptacle timer and the simplex receptacle in position to be received by the channel support;

FIG. 50 is a perspective view of a channel support similar to the view of FIG. 49, but showing a receptacle timer assembly as an element separate from a simplex receptacle assembly in position to be received by the channel support;

FIG. 51 is a perspective view of the channel support shown in FIG. 49, with the duplex receptacle timer and simplex receptacle in a fully assembled position within the channel support, and further showing the end covers in position to be received by the channel support;

FIG. 52 is a perspective view of the channel support shown in FIG. 51, in a fully assembled position;

FIG. 53 is a perspective view of a fully assembled channel support with a duplex receptacle timer and simplex receptacle assembly therein, and substantially similar to the view of FIG. 52;

FIG. 54 is a perspective view of another type of power and data center which may be utilized in accordance with the invention, and having a receptacle timer therein;

FIG. 55 is a perspective view of a still further power and data center having a receptacle timer therein, with the power and data center being adapted to clamp onto the edge of a work surface or similar table;

FIG. 56 is a perspective view of another power and data center in accordance with the invention, and showing the use of a receptacle timer therein for enabling and disabling the electrical and data elements in the power and data assembly;

FIG. 57 is a perspective view of a work surface having a power and data center clamped to the edge of the work surface, with the power and data center substantially corresponding to the power and data center shown in FIG. 55, and further showing a receptacle timer in accordance with the invention having the capability of communicating with the power and data center through spatial signals;

FIG. 57A is an enlarged view of the receptacle timer associated with the power and data center shown in FIG. 57, with the enlargement taken within the circle identified as circle 57A in FIG. 57;

FIG. 58 is a perspective view showing a conventional outlet receptacle block, having one outlet receptacle and a receptacle timer associated therewith, and further showing a set of buttons for purposes of manual operation by the user;

FIG. 59 is a perspective view of an outlet receptacle block similar to the block shown in FIG. 58, but showing the user interface as being a dial, in place of the buttons;

FIG. 60 is a perspective view of a raceway assembly showing a pair of junction blocks, an end connector and a set of jumper cable assemblies, and further showing a pair of electrical receptacle blocks with receptacle timers therein, with the view showing the electrical receptacle blocks in an exploded configuration;

FIG. 61 is a perspective view showing the elements of FIG. 60 in a fully assembled state;

FIG. 62 is a perspective view showing a raceway assembly as positioned within a set of three panels, with the raceway assemblies including a junction block having an electrical receptacle block with a receptacle assembly and a receptacle timer therein; and

FIG. 63 is an enlarged view of the electrical receptacle block shown in FIG. 62 with a receptacle timer therein, with the enlargement taken within the circle identified as circle 63 in FIG. 62.

### DETAILED DESCRIPTION OF THE INVENTION

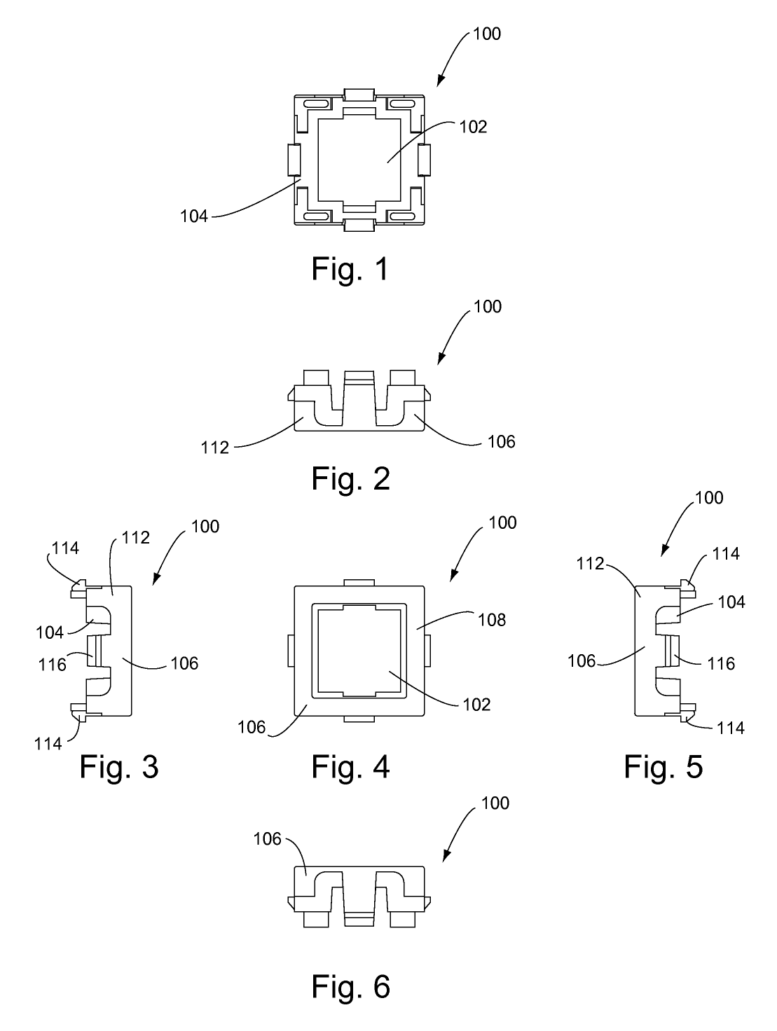

FIGS. 1-8 illustrate various views of a simplex receptacle housing 100. More specifically, FIG. 1 is a rear view of the receptacle housing. FIG. 2 is a plan view of the receptacle housing, while FIG. 3 is a left-side end view of the receptacle housing. FIG. 4 is a front, elevation view of the receptacle housing, while FIG. 5 is a right-side end view of the receptacle housing. FIG. 6 is an underside view of the receptacle housing.

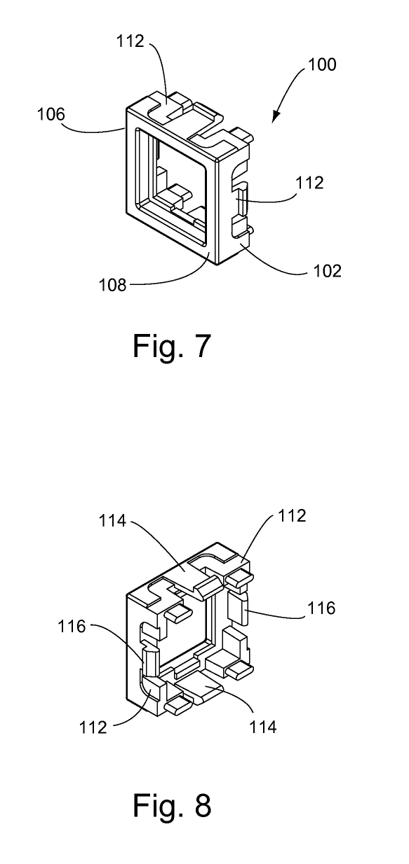

FIG. 7 is a front, perspective view of the receptacle housing. FIG. 8 is a rear, perspective view of the receptacle housing. With reference to these drawings, the receptacle housing 100 includes an opening 102 which is adapted to receive an outlet receptacle. The housing 100 includes a main body 104 with a front cover 106. The front cover 106 includes a face 108. The cover 106 also includes a set of sides 112. A pair of latch tabs 114 are positioned at upper and lower sides of the front cover 106. Side latch tabs 116 are positioned on opposing sides of the front cover 106.

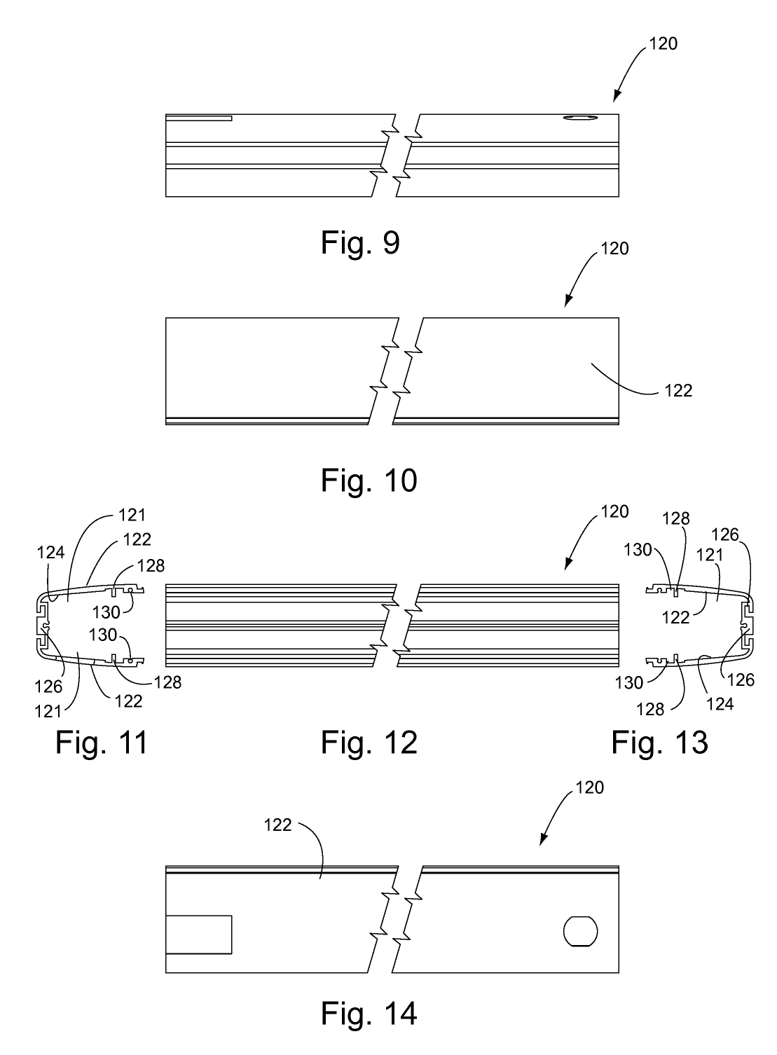

FIGS. 9-16 illustrate a power and data channel support 120. Various views of the channel support 120 are shown in FIGS. 9-16.

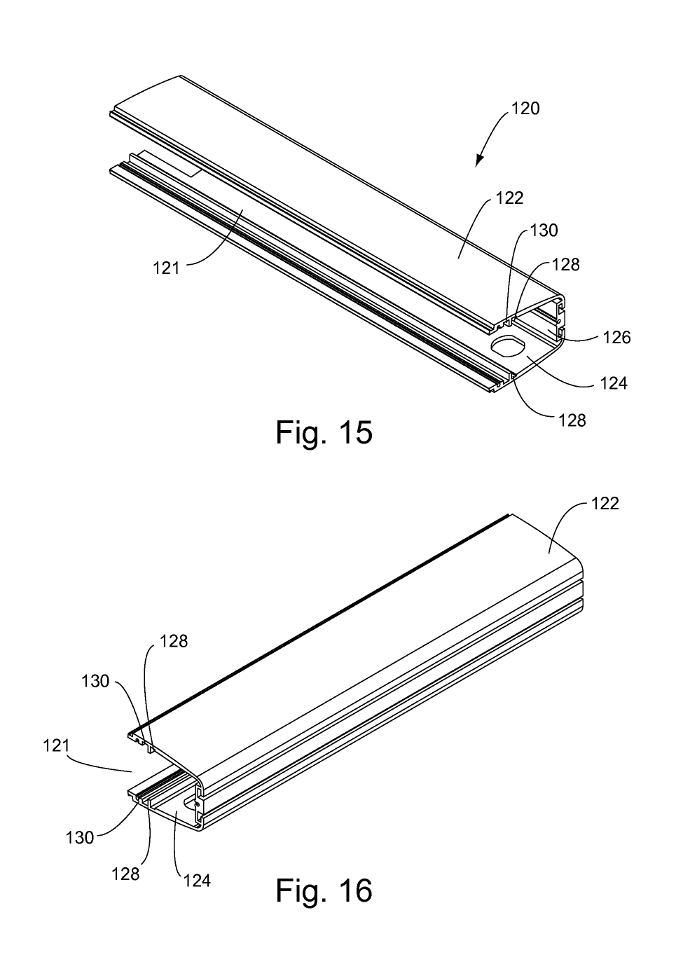

More specifically, FIG. 9 illustrates a rear, elevation view of the channel support 120. FIG. 10 illustrates a plan view of the support 120, while FIG. 11 illustrates a left-side end view of the support 120. FIG. 12 illustrates a front, elevation view of the channel support 120, while FIG. 13 illustrates a right-side end view of the support 120. FIG. 14 illustrates an underside view of the support 120. FIG. 15 illustrates a front, perspective view of the support 120, while FIG. 16 illustrates a rear, perspective view of the support 120. The channel support 120 includes an elongated channel 121 formed between a pair of opposing sides 122. The opposing sides 122 have inner side surfaces 124. The sides 122 are integral with or otherwise connected together with a floor section 126. At the upper portions of each of the inner side surfaces 124 is a longitudinally extending rib 128. Positioned immediately above the ribs 128 are a set of opposing upper channels 130.

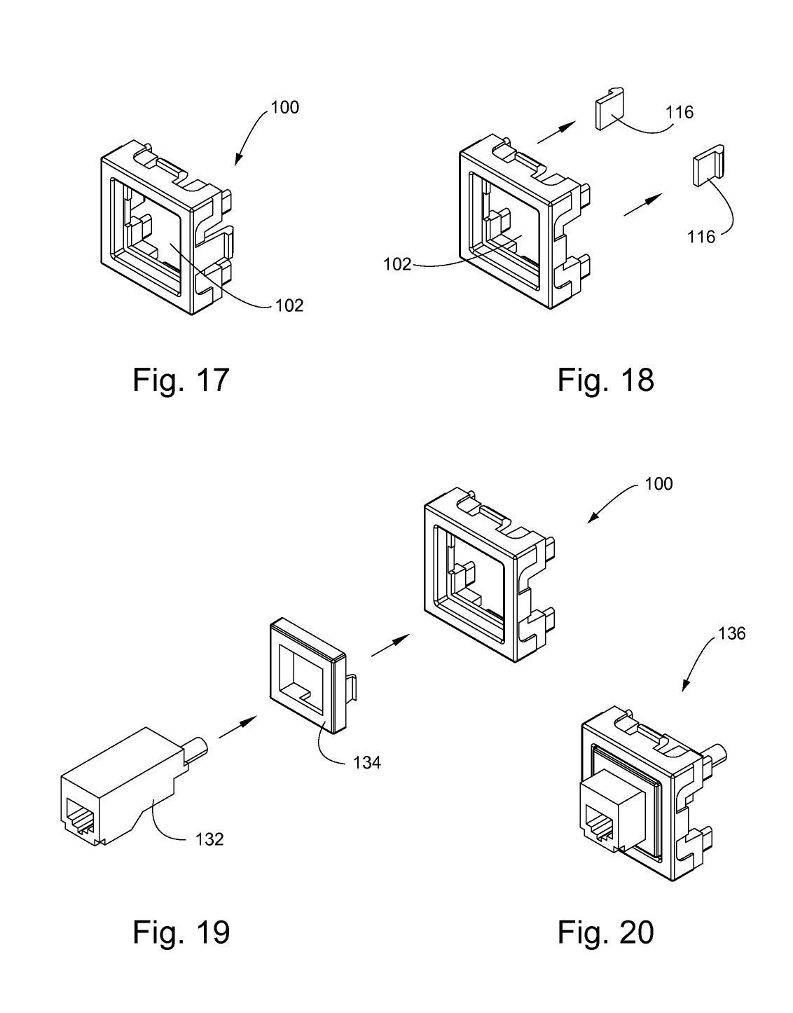

As previously described with respect to FIGS. 1-8, the invention provides for what can be characterized a receptacle housing 100. In fact, this housing 100 is capable of being utilized for various electrical elements, in addition to electrical receptacles. FIGS. 17-20 illustrate the use of the receptacle housing 100 with a data port connector 132 (FIG. 19) and data port insert 134 (also FIG. 19). The data port insert 134 can be received within the opening 102 of the housing 100, and secured to the housing 100 by means of the removable tabs 116. The data port insert 134 is sized so as to appropriately receive the data port connector 132. The resultant component is the data port assembly 136 shown in FIG. 20.

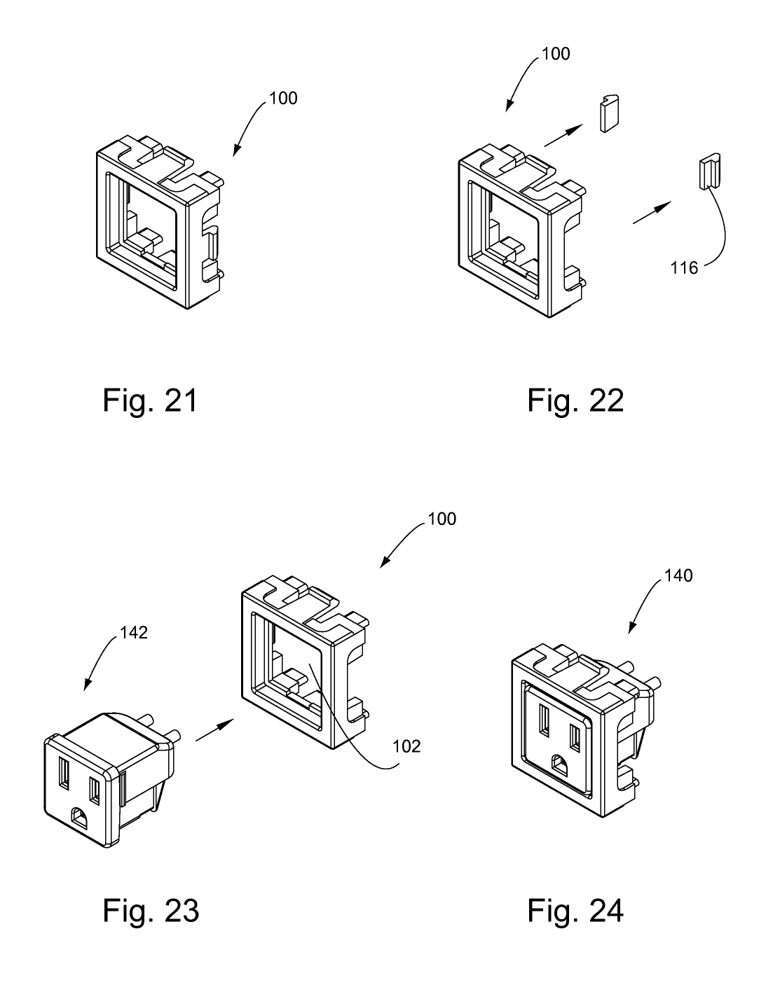

The housing 100 can also be used for other components, such as simplex receptacles. A simplex receptacle assembly 140 is shown in FIGS. 21-24. FIG. 24 shows a fully assembled simplex receptacle assembly. FIG. 21 shows the receptacle housing 100 previously described herein, and FIG. 22 shows the housing 100 with the removable tabs 116. FIG. 23 illustrates an exploded view showing the receptacle housing 100, with a simplex receptacle 142 positioned so as to be received within the opening 102. In this particular instance, an insert is not required, since the opening 102 is originally sized so as to receive the receptacle 142.

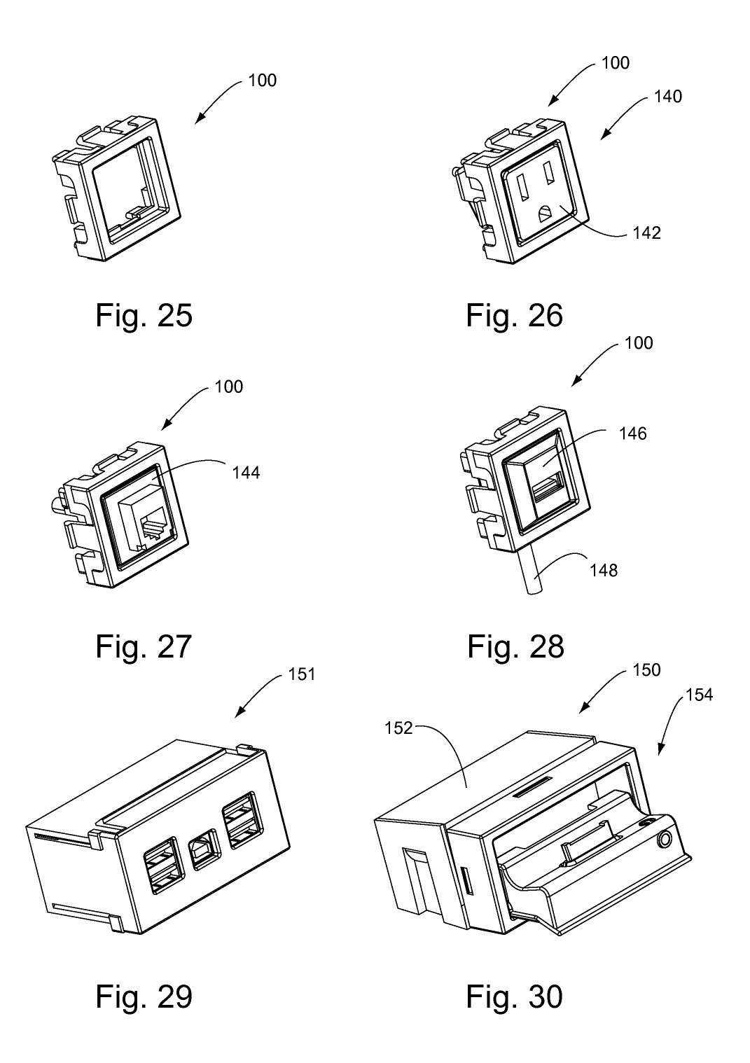

FIGS. 25-30 show other components which can be utilized with the adapter assembly in accordance with the invention. FIG. 25 again illustrates the housing 100, while FIG. 26 again shows the simplex receptacle assembly 140, with the receptacle 142 itself. FIG. 27 illustrates the use of the receptacle housing 100 with a data port 144. The data port 144 may or may not require an insert for the opening 102. FIG. 28 illustrates the use of the housing 100 with a USB port 146, and corresponding cable 148. Again, an insert may or may not be required.

FIG. 29 illustrates a data port housing 151 which may be used with the adapter assembly in accordance with the invention. FIG. 30 illustrates a docking station 150 in an open state, and showing the docking station components 154. The docking station 150 is disclosed in commonly owned U.S. Patent Application Ser. No. 61/131,403 filed Jun. 9, 2008, and titled “DOCKING STATION WITH POWER AND DATA CENTER.”

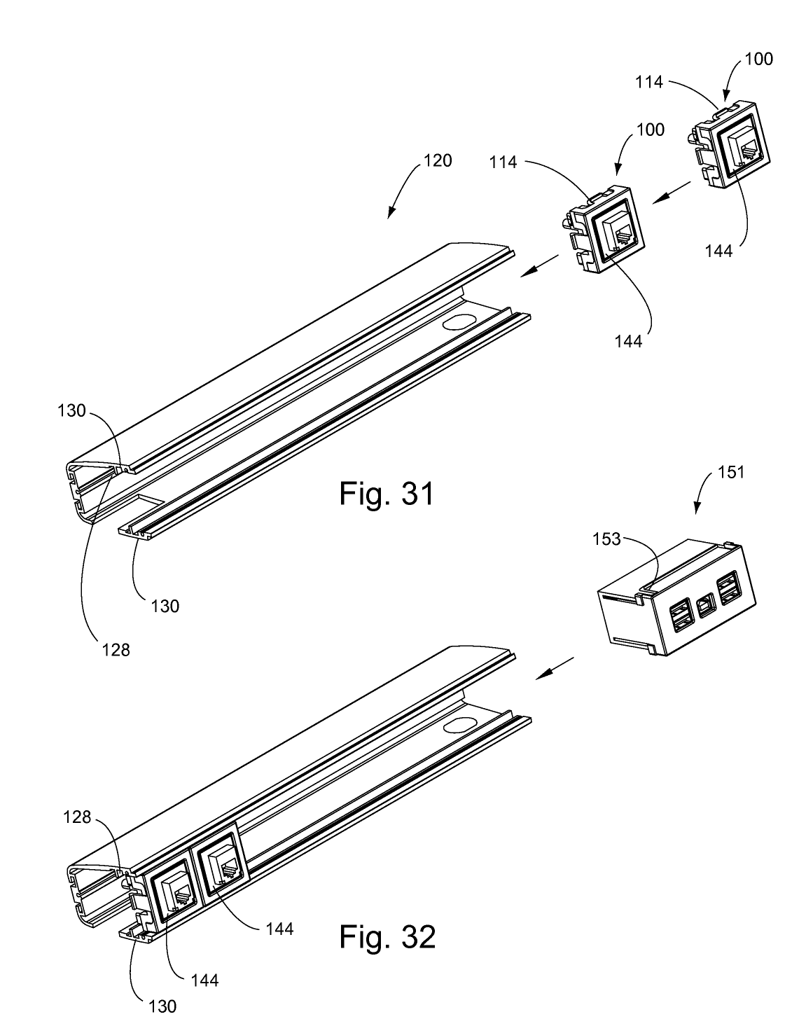

FIGS. 31 and 32 illustrate the manner in which certain electrical elements can be received within the channel support 120. Specifically, FIG. 31 illustrates the positioning of a pair of receptacle housings 100 with data ports 144 as they can be slidably received within the channel support 120. FIG. 32 shows the data ports 144 within the channel support 120. With this configuration, the latch tabs 114 on opposing sides of the housings 100 are received within the upper channels 130 of the channel support 120. FIG. 32 also shows the relative positioning of a data port housing assembly 151 as it is ready to be received within the channel support 120. The data port assembly housing 151 includes a pair of elongated and resilient latches 153 which are also received within the upper channels 130.

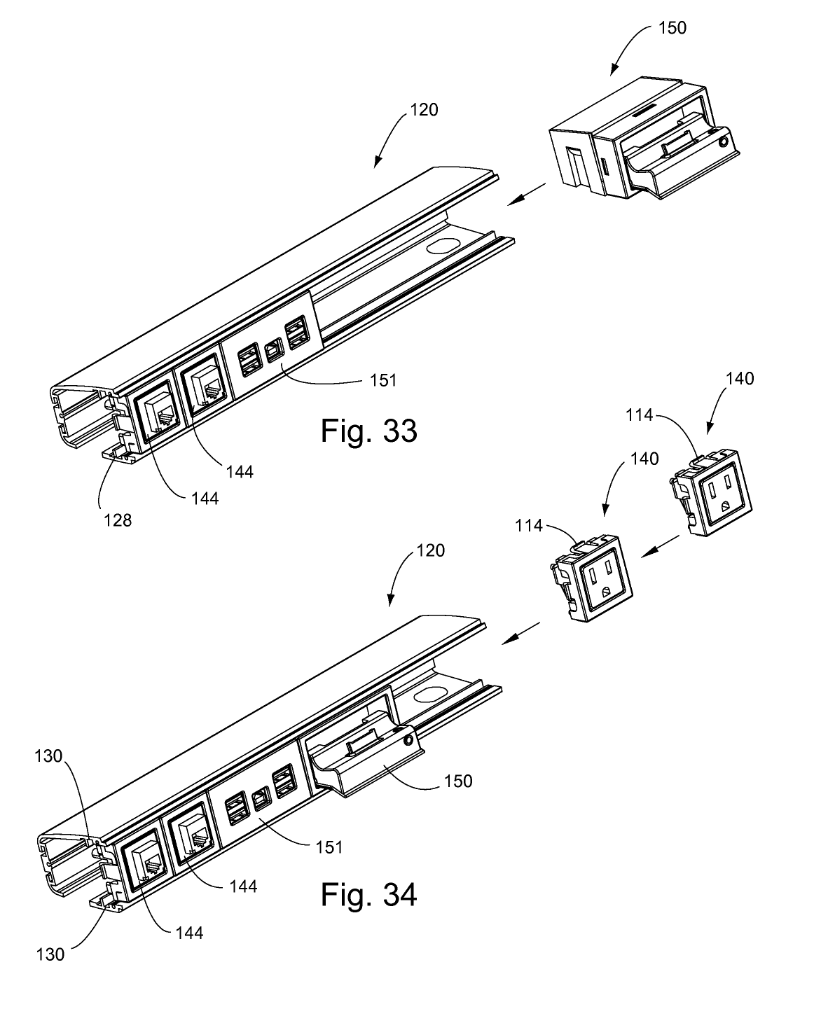

FIG. 33 is similar to FIG. 32, but illustrates the positioning of the docking station 150 so as to be received within the channel support 120. The docking station 150 can be positioned so as to slide between ribs 128 of the channel support 120.

FIG. 34 shows relative positioning of a pair of simplex receptacle assemblies 140, for reception within the channel support 120. Again, the latch tabs 114 will be received within the upper channels 130.

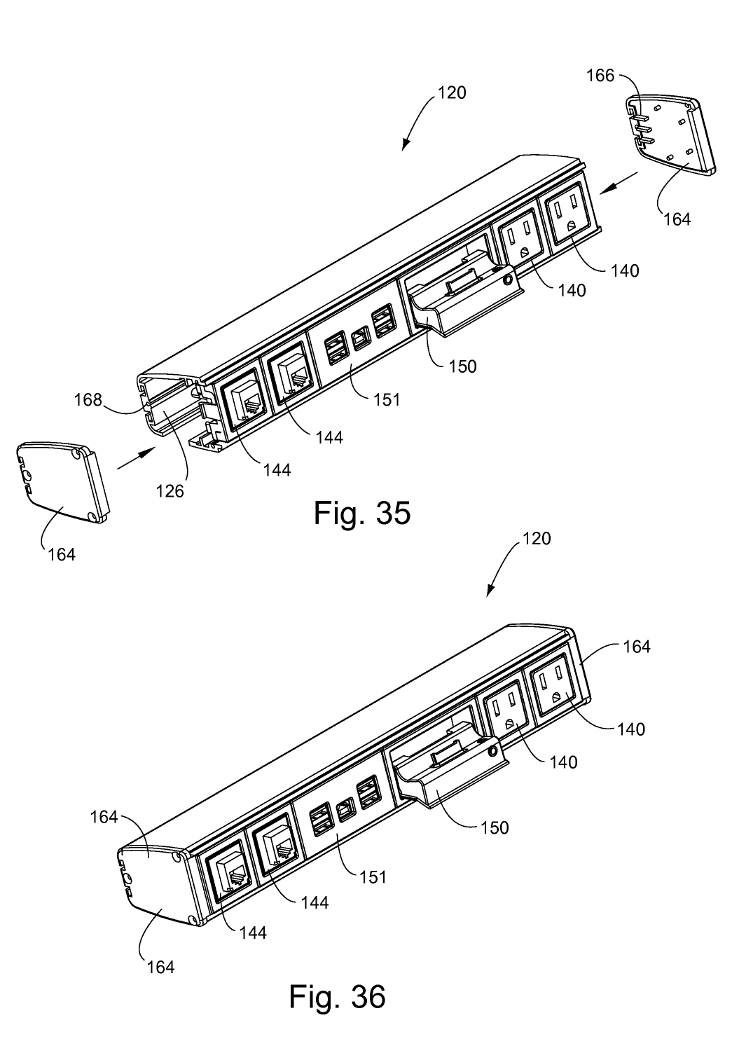

FIGS. 35 and 36 illustrate the channel support 120 fully assembled with the pair of data ports 144, data port assembly 151, data station 150, and the pair of simplex receptacle assemblies 140. FIGS. 35 and 36 also show (with FIG. 35 shown in exploded view) the relative position of a pair of side covers 164 which can be releasably secured to the channel support 120. The inner surfaces of the side covers 164 include sets of ribs 166. The ribs 166 cooperatively are received within channels 168 located within the floor section 126 of the channel support 120.

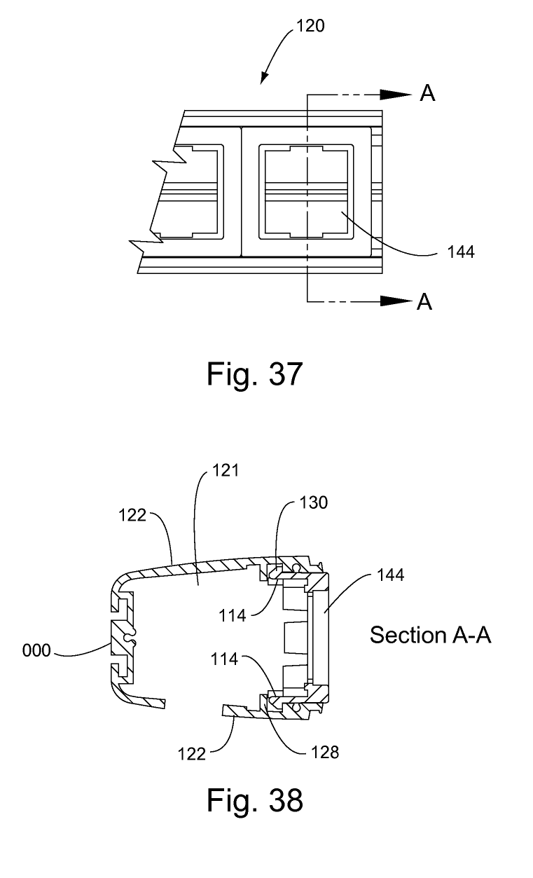

FIG. 37 shows a portion of a data port 144 as received within a portion of the channel support 120. FIG. 38 is a sectional view, taken along section lines 38-38 of FIG. 37. Specifically, FIG. 38 shows how the data port 144 is coupled to the channel support 120, through the latch tabs 114 being received within the channels 130. Also shown are the ribs 128.

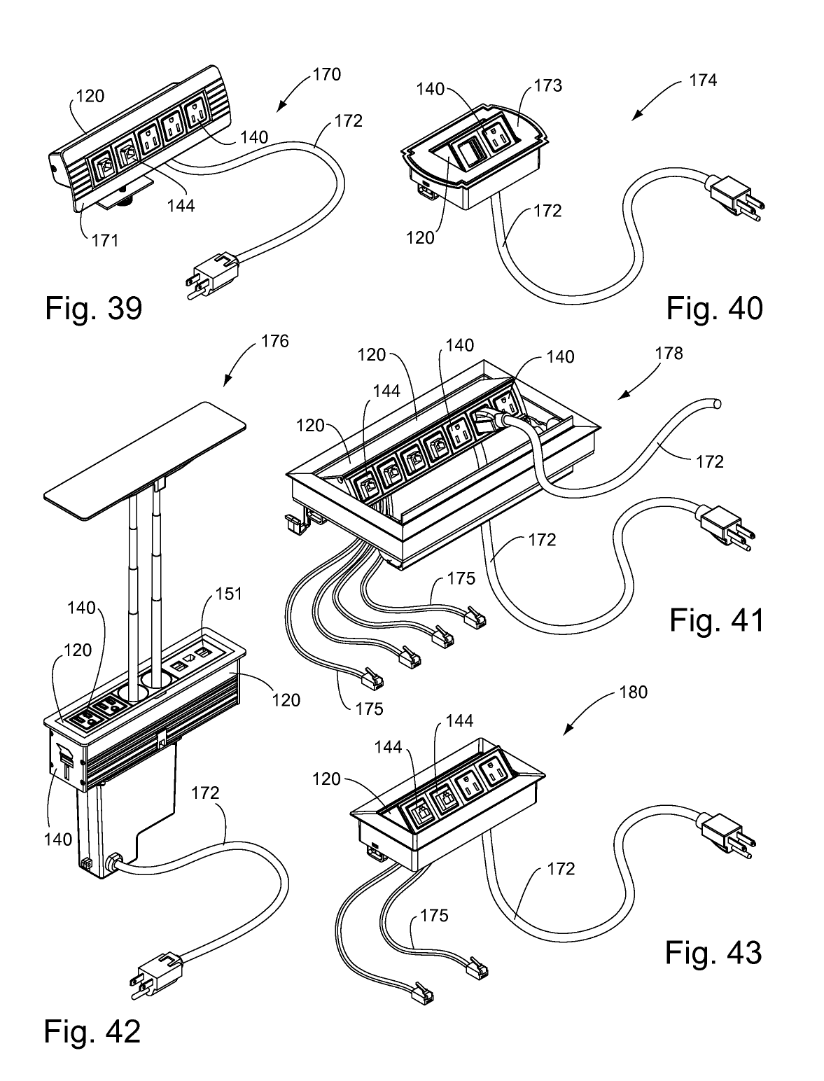

FIGS. 39-43 are perspective views showing various illustrations of various electrical assemblies utilizing the power and data adapter assembly in accordance with the invention, which incorporates the channel support 120. FIG. 39 is a perspective view of a power and data assembly 170, with a cord 172. The assembly 170 uses the channel support 120 and a cover plate 171. The assembly in FIG. 39 includes a pair of data ports 144 and three simplex receptacle assemblies 140.

Power and data assembly 174 shown in FIG. 40 includes a cord 172, with the channel 120 being received within a power and data housing 173. The assembly includes a single simplex receptacle assembly 140.

FIG. 41 illustrates a further power and data assembly 178. This power and data assembly 178 includes four data ports 144 and three simplex receptacle assemblies 140. Cords 172 and data cables 175 are also shown.

FIG. 42 illustrates the use of a channel support 120 with a pair of simplex receptacle assemblies 140, data port housing 151, and a retractable light assembly 176. Still further, FIG. 43 illustrates a further power and data assembly 180, using a channel support 120, with a pair of data ports 144 and a pair of simplex receptacle assemblies 140.

The foregoing has generally described concepts associated with power distribution assemblies having certain commonality among various types of electrical components. Also described were various types of power data housings for housing the various power and data distribution components, in a manner whereby the components can be selectively moved and repositioned relative to one another. As previously described in the section entitled “Background Of The Invention,” it would be advantageous to have the capability of enabling and disabling various power and data components at various times, without requiring any type of physical activity on the part of the user at the times that such components are to be enabled or disabled. That is, it would be advantageous to “shift” the time at which enablement and disablement could occur, without being restricted to the actual times that enablement and disablement are to occur.

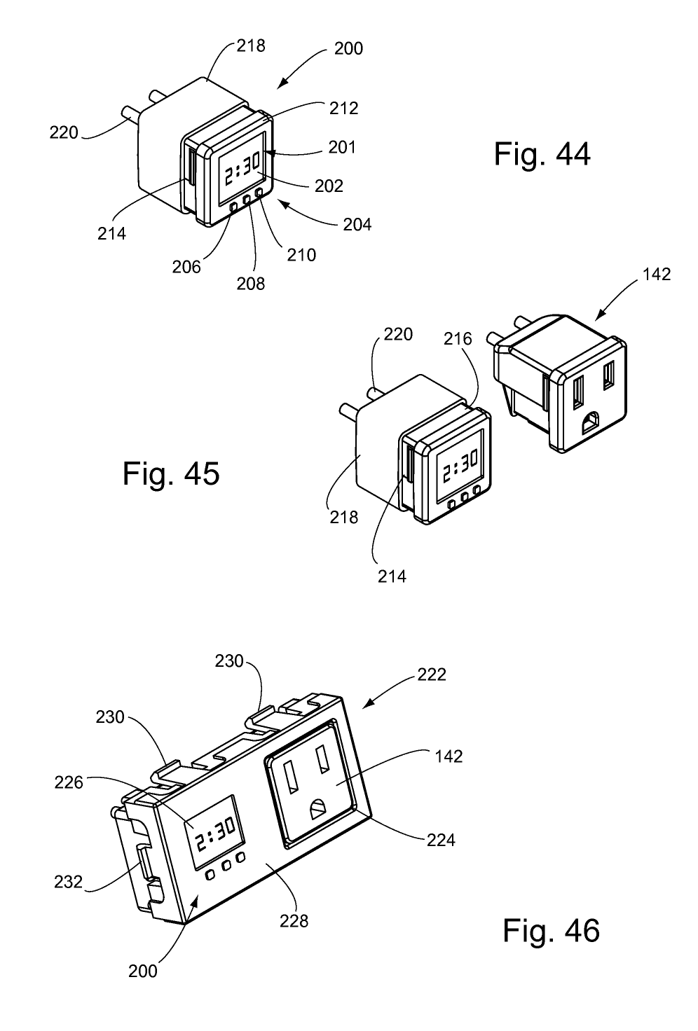

In accordance with these aspects of the invention, the principles of the invention are disclosed in various types of timer assemblies for use with power and data distribution components as described in subsequent paragraphs herein and illustrated in FIGS. 44-63. With reference thereto, a timer assembly 200 is illustrated in FIG. 44 and FIG. 45. The timer assembly 200 shown in FIG. 44 includes a timer face 202 having numerical digits which can, at various times, identify the current time, and can also be used to facilitate a user setting times for enablement and disablement of power and data distribution components which can be electrically associated with the timer assembly 200. For example, the numerical digits 201 shown on timer face 202 (which can be provided by LEDs or the like) may be used to show a “total” period of time during which associated power distribution components are to be enabled. Alternatively, the timer face 202 and numerical digits 201 can show a “start time” and an “end time” for enablement of associated power distribution assemblies. For example, the numerical digits 201 can be utilized to facilitate the user causing the timer assembly 200 to enable a power distribution component at 2:30 pm, and disable the same power distribution component at 5:30 pm.

Also to facilitate use of the timer assembly 200, a set of controls 204 can be positioned on a timer front housing 212. The controls 204 can be connected to various other electrical components associated with the timer assembly 200, so as to control the setting and resetting of the timer functions. For example, the controls 204 could include a set control 206, reset control 208 and time control 210. The set control 206 can be utilized to actuate an initial enablement time and a disablement time for the assembly 200. The reset control 208 can essentially nullify prior control instructions. The timer control 210 can be utilized to adjust the time (or other representations corresponding to the numerical digits 201) as desired by the user.

Electrical components associated with the timer assembly 200 can be conventional and are not described in detail herein. The electrical components can be positioned behind a timer front housing 212 within a timer body 216. The timer body 216 can be releasably coupled to other electrical housing components (such as those previously described herein) through the use of releasable timer side latches 214 (one of which is shown in FIG. 44). A timer sheath 218 can circumscribe the timer body 216, and could be made of appropriate components so as to shield the electrical components of the timer assembly 200 from external electrical and magnetic interference.

FIG. 45 illustrates the timer assembly 200 as being positioned physically adjacent a simplex receptacle 142. As shown in FIG. 46, the simplex receptacle 142 and the timer assembly 200 can be positioned within a duplex housing 222. As also shown in FIG. 46, the duplex housing 222 includes a power/data aperture 224 through which the simplex receptacle 142 can be received. This particular duplex housing 222 also has a small timer aperture 226 through which the timer face 202 may be viewed. The aperture 224 and aperture 226 exist within a front duplex face 228. The front duplex face 228 can be coupled to a pair of rearwardly extending top latches 230. The latches 230 can be utilized to releasably secure the duplex housing 222 to a channel support, such as the channel support 120 previously described herein. The latches 232 or latch tabs 232 correspond to latch tabs 114 previously described with respect to the housing 100. Correspondingly, the side latches 232 can be utilized to secure the duplex housing 222 to the timer assembly 200 through coupling with the timer side latches 214.

With the foregoing configuration, power can be supplied to the timer assembly 200 and the simplex housing 142 through wire or cable connectors 220. Further, although not expressly shown in the drawings, the connectors 220 can be interconnected to each other for the assembly 200 and the housing 142, so as to provide the capability of control of enablement and disablement of the electrical power supply to the simplex housing 142, based on the settings of the timer assembly 200. Also, the electrical interconnection which occurs between the timer assembly 200 and the simplex housing 142 can be made “indirect,” in that electrical interconnection can be made through other components which may be somewhat separate and independent from the component shown in FIG. 46. For example, the timer assembly 200 can be connected to a relay or similar device. The relay or similar device can then be connected to the simplex housing 142 in a manner so that enablement and disablement of the electrical power supplied to the simplex housing 142 can be controlled through the relay which, in turn, is controlled through signals supplied from the timer assembly 200. That is, the timer assembly 200 can translate control signals for controlling whether electrical power is supplied to the simplex housing 142. This can also be made true if the simplex housing 142 comprises a data port or the like.

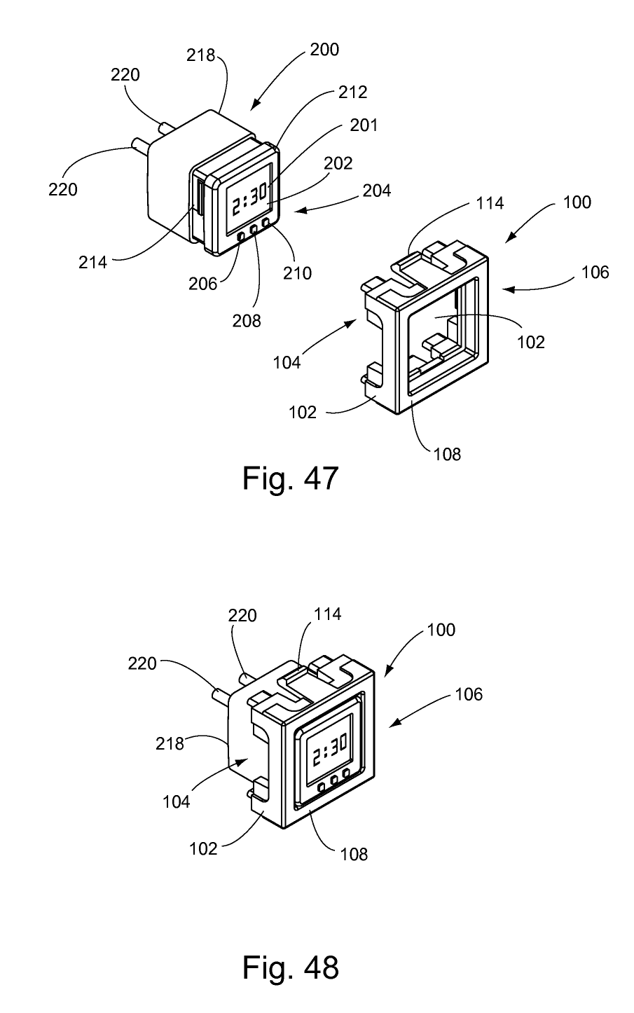

The timer assembly 200 can be used with other configurations, separate from the duplex housing 222. For example, FIG. 47 shows an exploded view of the timer assembly 200 positioned adjacent to the simplex receptacle housing 100. As previously described herein, the simplex receptacle housing 100 includes a front opening 102, main body 104, front cover 106 and face 108. The housing 100 also includes sides 112, and latch tabs 114 (only one of the latch tabs 114 being shown in FIG. 47). As shown in FIG. 48, the simplex housing 100 is adapted to receive the timer assembly 200, with the timer face 202 being received within the opening 102. The fully assembled timer assembly 200 and simplex receptacle housing 100 is illustrated in FIG. 48. The combination of the housing 100 and timer assembly 200 can be readily adapted to be received within the channel support 120 previously described herein. As previously described herein, the timer assembly 200 can be coupled to any of a number of other power and data distribution components, for purposes of controlling enablement and disablement of such components.

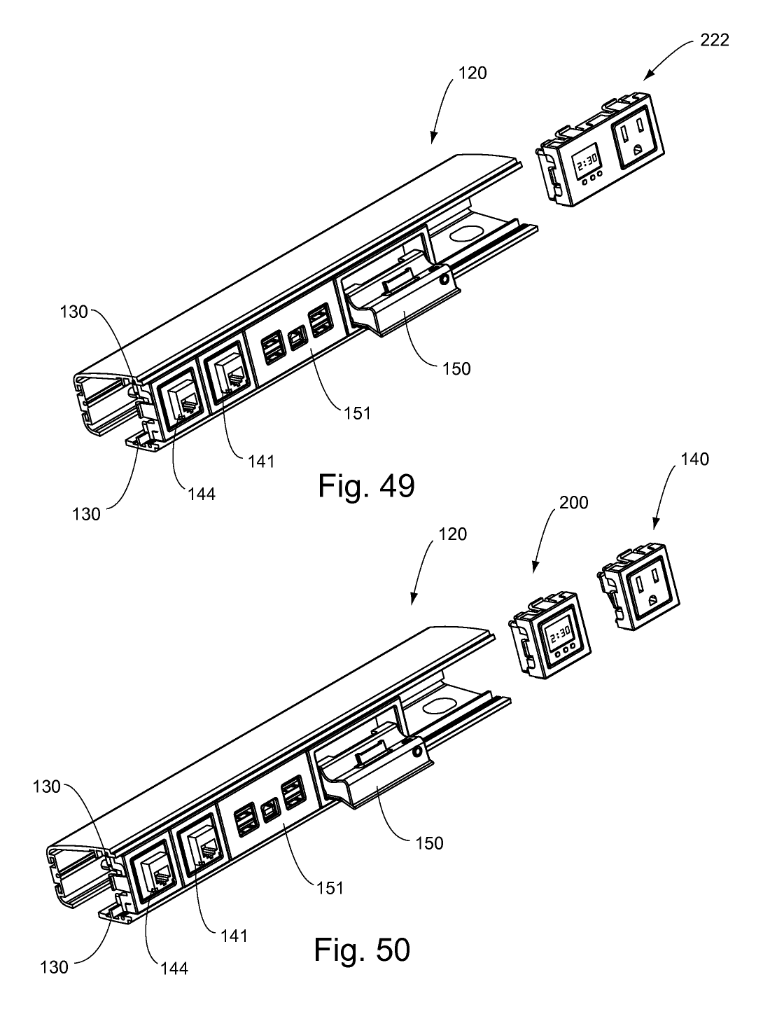

In accordance with the invention, the timer assembly 200 as described herein requires no structural housing parts which need to be designed in a manner which are structurally different from the various housing parts utilized with the power and data distribution components described herein. For example, FIG. 49 illustrates the channel support 120 with various power and data distribution components as previously illustrated in FIG. 34 and also previously described herein. However, instead of having a pair of simplex receptacle assemblies 140 as shown in FIG. 34, FIG. 49 shows the channel support 120 with the duplex housing 222 and associated timer assembly 200 previously described herein, and illustrated in FIG. 46. It should be noted that the duplex housing 222 can be slideably received within the channel support 120 in the same manner as the other components shown in FIGS. 34 and 49. That is, the duplex housing 222 can be slideably received within the channel support 120 in the same manner as the data ports 144, docking station 150 and data portion housing 151. Similarly, FIG. 50 illustrates the channel support 120 with the same previously described power and data components as shown in FIG. 49, but with the timer assembly 200 shown as a component separate from but adjacent to a simplex receptacle assembly 140. The simplex receptacle assembly 140 can correspond to that shown in FIG. 24. FIG. 50 shows the relative positioning of the timer assembly 200 and simplex receptacle assembly 140 as they can be received within the channel support 120.

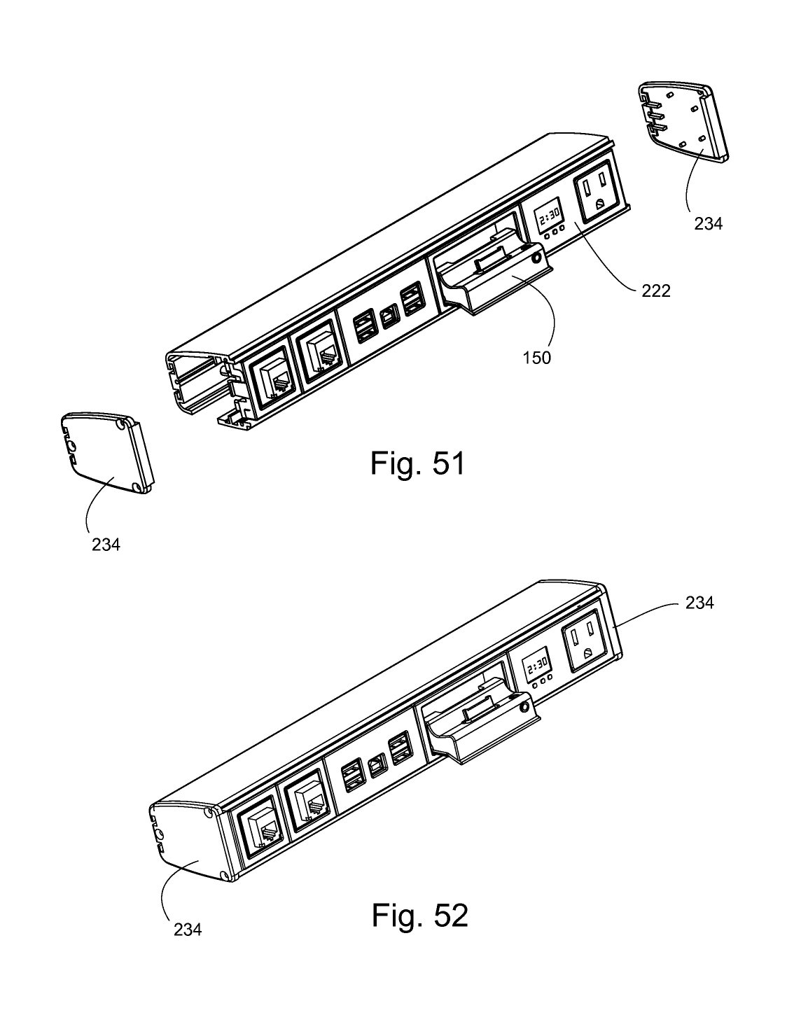

FIG. 51 illustrates the channel support 120 with the duplex housing 222 as previously shown in an exploded view in FIG. 49. However, FIG. 51 shows the duplex housing 222 as received and releasably secured within the channel support 120. Further, FIG. 51 shows a relative positioning of a pair of opposing side covers 234 which can be utilized to cover the sides of the channel support 120. FIG. 52 illustrates the side covers 234 and the channel support 120 in a fully assembled configuration.

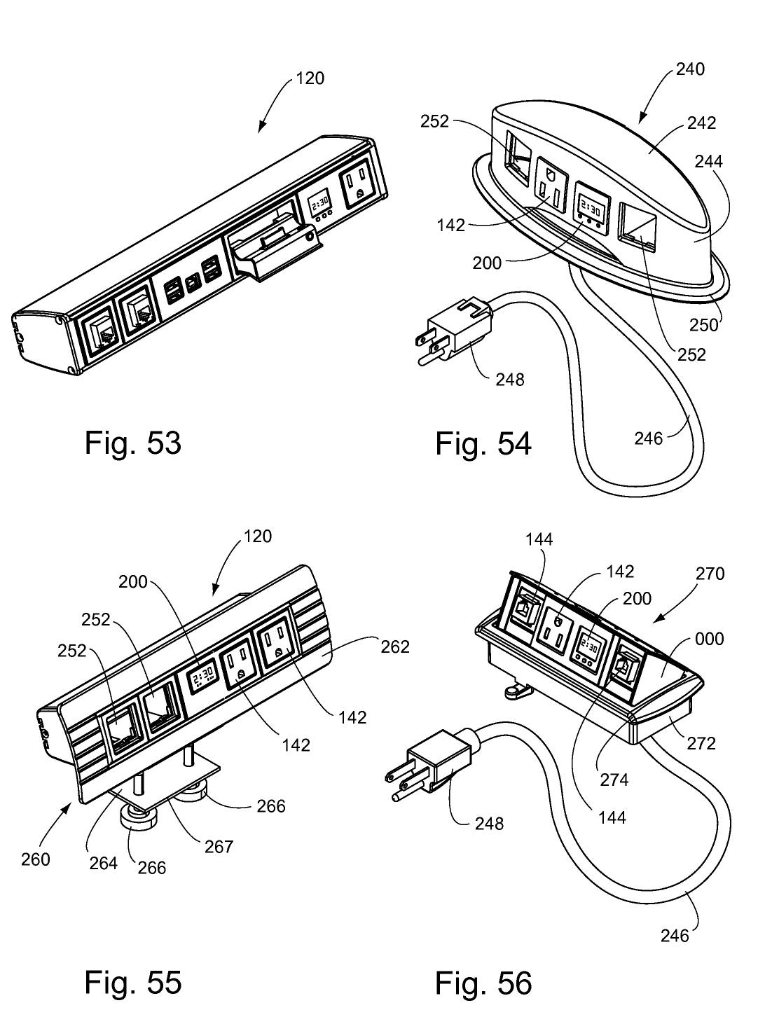

FIGS. 53-56 illustrate the use of the timer assembly 200 in various configurations of power and data distribution assemblies. FIG. 53 essentially shows the use of the timer assembly 200 within a channel support 120, in a manner substantially similar to that shown in FIG. 52. FIG. 54 illustrates the use of the timer assembly 200 within a power and data distribution assembly having a configuration different than that shown in FIG. 53 and others using the channel support 120. Specifically, FIG. 54 illustrates the use of a shaped distribution assembly 240. The shaped distribution assembly 240 is also adapted for use on a work surface or the like, and includes a top 242 and rounded sides 244, which may be molded to the top 242. A cord 246 extends from the bottom or rear of the assembly 240, with a plug 248 connected at a determining end thereof. The distribution assembly 240 includes a pair of apertures 252 extending outwardly from a front portion of the rounded sides 244 at opposing ends thereof. Positioned between the apertures 252 is an opening through which the timer assembly 200 can be received and viewed. Adjacent to the timer assembly 200 is a simplex receptacle 142 which also extends through an opening of the distribution assembly 240.

A further housing assembly is illustrated in FIG. 55 as housing assembly with face structure 260. The assembly 260 includes a channel support 120 at the rear portion thereof, with the channel support having a configuration which may be similar to that of any of the other embodiments utilizing channel support 120. Positioned at the forward portion of the channel support 120 and releasably secured thereto is a face plate 262. Positioned within the face plate 262 are a pair of apertures 252, through which various power and/or data assemblies may be received. Also received through openings of the face plate 262 are a pair of simplex receptacles 142. Positioned near the center of the face plate 262 is a timer assembly 200, which may be electrically coupled to the simplex receptacle 142 or other components for purposes of controlling enablement and disablement.

The assembly 260 is particularly adapted for mounting on the edge of a work surface or otherwise to an aperture of the work surface. For purposes of securing the assembly 260 to a work surface, the assembly 260 includes a clamp plate 264, with a pair of clamping bolts 266 extending through apertures thereof. The clamping bolts 266 can be manipulated so as to position the clamp plate 264 along the longitudinal length of the clamping bolts 266. This positioning can then be utilized to secure appropriate components to the work surface.

A still further assembly is shown in FIG. 56 as rotatable housing assembly 270.

The assembly 270 includes a lower housing 272 which can be received within an aperture of a work surface or the like. A grommet 274 is positioned above the lower housing 272, for providing a surface which could be relatively flush with the work surface. Positioned within the interior of the lower housing 272 and grommet 274 is a rotatable carriage 276 which can be moved between a closed, retracted position and an open, extended position. FIG. 56 illustrates the carriage 276 in the open, extended position. In this position, various electrical components can be utilized. For example, in FIG. 56 the carriage 276 is shown as having a pair of data ports 144 positioned at opposing sides of the carriage. A simplex receptacle 142 is positioned between the data ports 144, along with a timer assembly 200. The timer assembly 200 can be utilized to control the data ports 144, as well as the simplex receptacle 142.

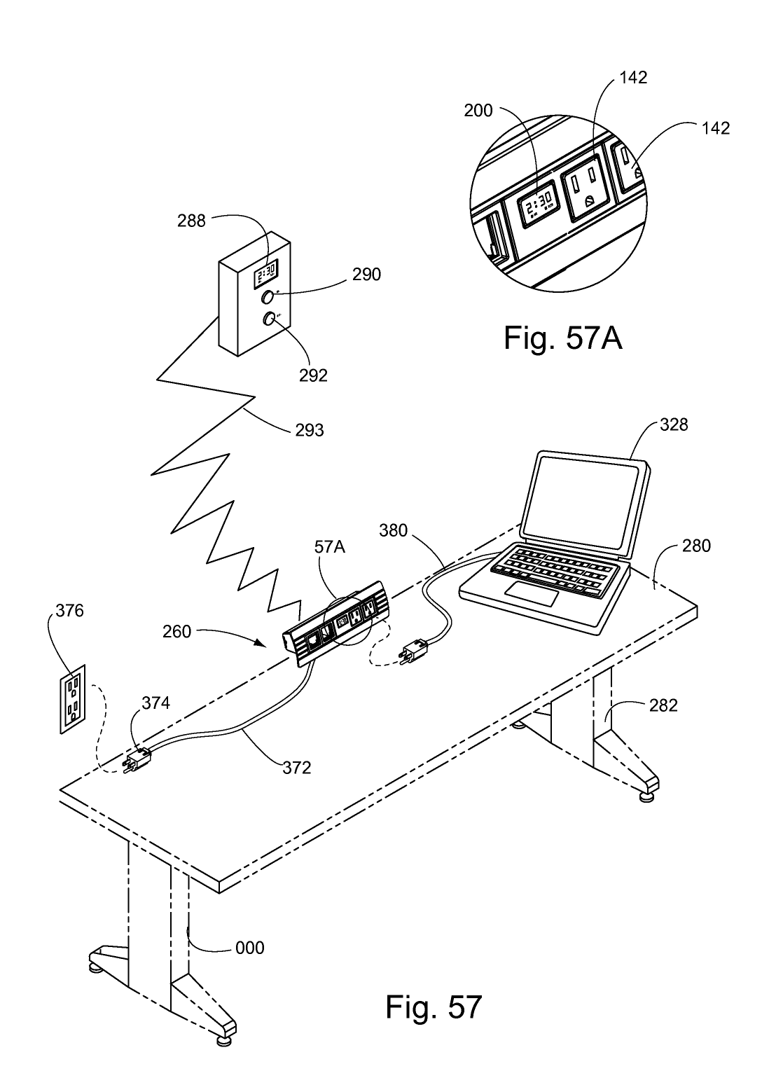

FIGS. 57 and 57A illustrate the housing assembly with face structure 260 as secured to a work surface 280 supported by legs 282 and 284. In the particular embodiment shown in FIG. 57, the timer assembly 200 which is positioned on the work surface 280 is actually controlled through a remote control device 286. The remote control device 286 can include a clock 288 with controls 290 and 292. Of course, various other control configuration can be utilized with a remote control device 286 having the functions associated herewith. Specifically, the remote control device 286 is utilized to transmit spatial signals 293 from the remote control device 286 to the timer assembly 200, for purposes of controlling the timer assembly 200 from a remote location. Of course, the spatial signals 293 could also be in a form of signals carried by conductors or the like, with conductive connections between the remote control device 286 and the timer assembly 200.

FIGS. 57 and 57A further show illustrations of particular nomenclature which may be used in the description of the invention. For example, the elements shown within the box in phantom line format identified as box 370 in FIG. 57 can be characterized as a power distribution assembly or system 370. In fact, the combinations of the electrical components described herein, including the timer assembly 200 and its various embodiments, can all be described as various types of power distribution assemblies or systems. Further, the housing assembly with face structure 260 is shown as being connected through a power cord 372 and plug 374 to a power source 376. The power source 376 can be any type of external power source, such as AC electrical power, battery power or the like. The purpose of the power source 376 is to power those electrical components associated with the power distribution assembly 370 required for purposes of energizing external devices. Also, it should be noted that the cord 372 and plug 374 can be connected to a source of communication or data signals. Accordingly, component 376 could be in the form of some type of source of communication signals, such as a telephone jack or the like. Further, and as also shown in FIG. 57, the housing assembly with face structure 260 can be connected through a cable 380 for powering or providing communication signals to external devices. In FIG. 57, an external device 378 is shown as a computer 378. It should be emphasized that the cable 380 may be a source of electrical power or, alternatively, may also be a source of communication or other data signals. In any event, the cable 380 can be “plugged into” various electrical components, such as one of the simplex receptacles 142 shown in FIG. 57 and FIG. 57A.

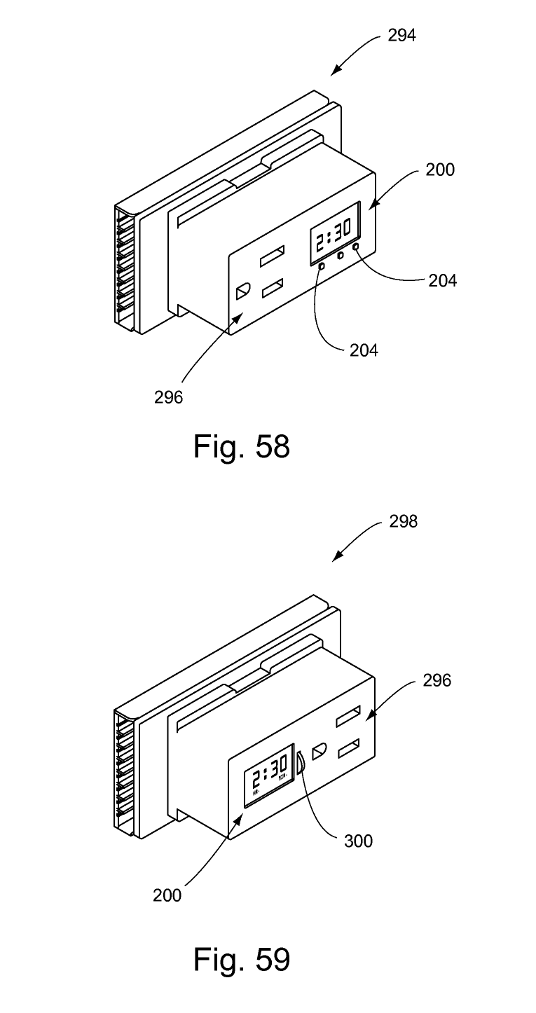

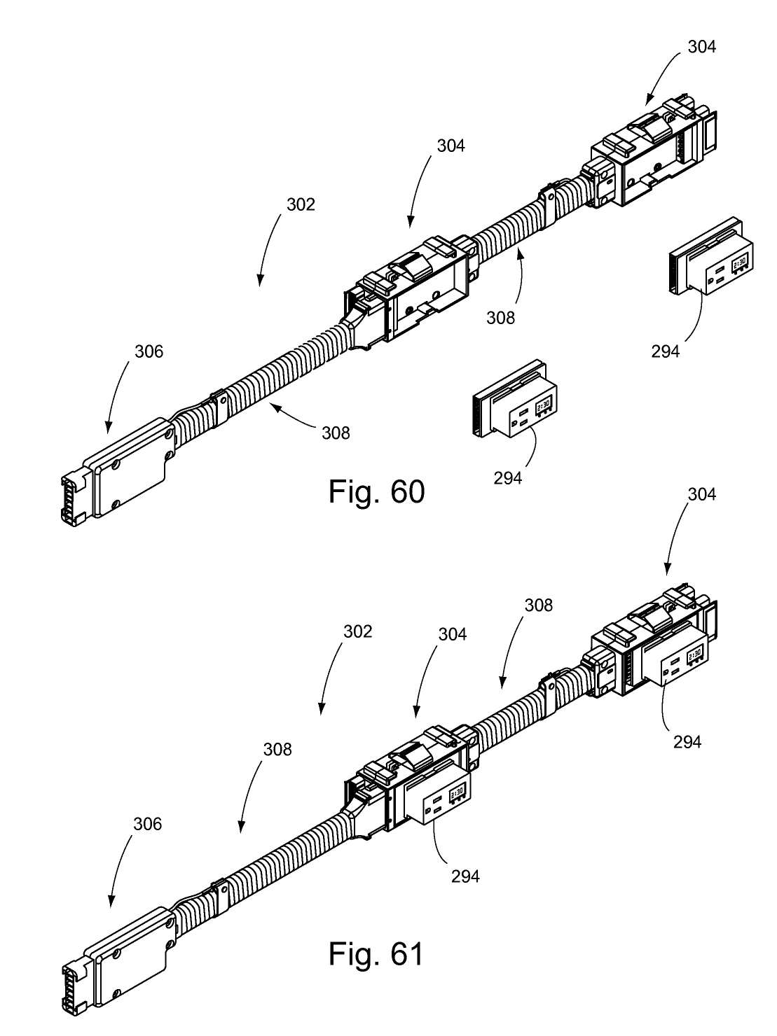

FIGS. 58 and 59 show the use of the timer assembly 200 as embedded within electric receptacle blocks. FIG. 58 shows an electrical receptacle block 294, while FIG. 59 shows an electrical receptacle block 298. Electrical receptacle blocks substantially corresponding to the blocks 294 and 298 are (absent any type of time assemblies) disclosed in the prior art, including, for example, the U.S. Pat. No. 5,096,431 to Byrne. Referring to FIG. 58, the receptacle block 294 is adapted to be received within a junction block or similar component of an electrical raceway or the like. Such electrical raceways are shown in FIGS. 60 and 61 as electrical raceways 302 having junction blocks 304. The junction blocks 304 are interconnected by conduit 308. End connectors 306 are positioned at terminating ends of each of the raceway assemblies 302. Returning to FIGS. 58 and 59, FIG. 58 shows the receptacle block 294 as having a three-prong receptacle 296 and the timer assembly 200. Electrical receptacle block 298 is similar, in that it also includes a three-prong receptacle 296 and timer assembly 200. However, the timer assembly 200 associated with the receptacle block 298, instead of including controls 204, includes a dial control 300. The dial control 300 could actually include multiple dials or the like for purposes of controlling the timer assembly 200. Accordingly, a number of different types of controls may be utilized with the timer assembly 200, without departing from the novel concepts of the invention.

Returning again to FIG. 60, FIG. 60 shows the raceway 302 having the junction blocks 304 with the receptacle blocks 294 positioned so as to be received within recesses within the junction blocks 304. FIG. 61 illustrates the receptacle blocks 294 as being fully positioned within the junction blocks 304.

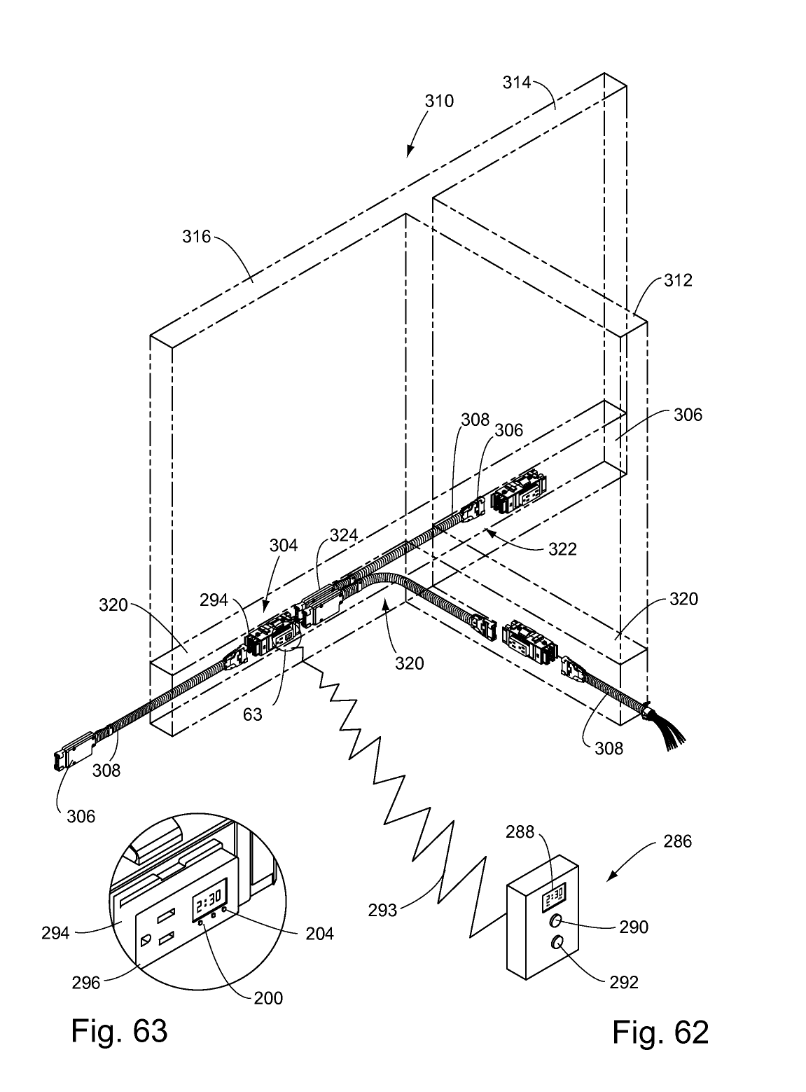

FIG. 62 illustrates a panel system 310 having a pair of panels 314 and 316 which are integral with each other, or otherwise coupled together in a straight line configuration. Panel 312 is shown in FIG. 62 as being positioned perpendicular to the panels 314, 316. With this configuration, an electrical receptacle block 294 is shown (particularly in FIG. 63) as being received within a junction block 304 within a raceway housing 320. The raceway housing 320 houses a raceway assembly 322 having an end connector 306, conduit cable 308 and cable connectors 324. The timer assembly 200 is shown as being controlled alternatively by controls 204 on the timer assembly 200 or the remote control device 286 having the clock 288 and controls 290, 292. The remote control device 286 can be utilized to send spatial signals 293 to the receptacle block 294 and the timer assembly 200. In this manner, the various electrical components associated with the raceway assembly 322 can be coupled to the timer assembly 200 and controlled with respect to enablement and disablement.

It will be apparent to those skilled in a pertinent arts that other embodiments of the receptacle timer assemblies in accordance with the invention can be designed. That is, the principles of the invention are not limited to the specific embodiments described herein. Accordingly, it will be apparent to those skilled in the art that modifications and other variations of the above-described illustrative embodiments of the invention may be effected without departing from the spirit and scope of the novel concepts of the invention.

1. A power distribution assembly for supplying electrical power and/or communication signals from an energy source and/or communication signal source, and adapted to be positioned on a work surface or the like, said distribution assembly comprising:
a first electrical component connectable to a source of electrical power or communication or data signals, for supplying said electrical power or communication or data signals to an external device connectable to said first electrical component;
a channel support mountable to said work surface, with said first electrical component being slidably received within said channel support;
a timer assembly directly or indirectly connectable to said first electrical component, for controlling enablement and disablement of said first electrical component; and
said timer assembly being slidably received within said channel support.

2. A power distribution assembly in accordance with claim 1, characterized in that said timer assembly comprises a set of controls mounted on said timer assembly, and operable by a user for controlling said enablement and disablement of said first electrical component.

3. A power distribution assembly in accordance with claim 1, characterized in that said power distribution assembly comprises a plurality of electrical components, each connectable to a source of electrical power or communication or data signals; and
said timer assembly is directly or indirectly connectable to each of said plurality of electrical components, for controlling enablement and disablement of each of said plurality of electrical components.

4. A power distribution assembly in accordance with claim 1, characterized in that said first electrical component and said timer assembly are sized and configured so as to be slidably received within said channel support and positionable at any of a continuum of positions within said channel support.

5. A power distribution assembly in accordance with claim 1, characterized in that said assembly further comprises a remote control device manually operable by said user for controlling said timer assembly, said control of said timer assembly being achieved through transmission of spatial signals from said remote control device to said timer assembly.

6. A power distribution assembly in accordance with claim 1, characterized in that said timer assembly comprises:
a timer face having numerical digits thereon; and
a set of controls manually operable by said user for setting times for enablement and disablement of said first electrical component.

7. A power distribution assembly in accordance with claim 1, characterized in that said assembly further comprises a face plate connectable to a front of said channel support, with said face plate having apertures therein for receiving said first electrical component and said timer assembly.

8. A power distribution assembly in accordance with claim 7, characterized in that
said assembly further comprises clamping elements connected to said channel support, for releasably securing said channel support to said work surface.

9. A power distribution assembly for supplying electrical power and/or communication signals from an energy source and/or communication signal source, and adapted to be positioned on a work surface or the like, said distribution assembly comprising:
a first electrical component connectable to a source of electrical power or communication or data signals, for supplying said electrical power or communication or data signals to an external device connectable to said first electrical component;
a housing adapted to be mounted within said work surface, and having an opening therein for receiving other components of said distribution assembly;
a rotatable carriage rotatably mounted within said housing, and adapted to be movable between a closed, retracted position and an open, extended position;
a timer assembly directly or indirectly connectable to said first electrical component, for controlling enablement and disablement of said first electrical component; and
said first electrical component and said timer assembly are received within and mounted to said rotatable carriage.

10. A power distribution assembly for supplying electrical power and/or communication signals from an energy source and/or communication signal source, and adapted to be positioned on a work surface or the like, said distribution assembly comprising:
a first electrical component connectable to a source of electrical power or communication or data signals, for supplying said electrical power or communication or data signals to an external device connectable to said first electrical component;
a timer assembly directly or indirectly connectable to said first electrical component, for controlling enablement and disablement of said first electrical component; and
an electrical receptacle block adapted to be mounted within a junction block of said power distribution assembly, with said first electrical component and said timer assembly being mounted within said electrical receptacle block.

11. A power distribution assembly in accordance with claim 10, characterized in that:
said power distribution assembly comprises an electrical raceway having components comprising end connectors, cable conduits and junction blocks; and
said electrical receptacle block carrying said first electrical component and said timer assembly are received within one of said junction blocks.
